(19) United States
(12) Patent Application Publication
(10) Pub. No.: US 2017/0260652 A1
(43) Pub. Date: Sep. 14, 2017

(54) NOZZLE HEAD AND ELECTROSPINNING APPARATUS

(71) Applicant: Kabushiki Kaisha Toshiba, Minato-ku (JP)

(72) Inventor: Shizuo KINOSHITA, Yokohama (JP)

(73) Assignee: Kabushiki Kaisha Toshiba, Minato-ku (JP)

(21) Appl. No.: 15/460,590

(22) Filed: Mar. 16, 2017

Related U.S. Application Data
(63) Continuation of application No. PCT/JP2016/076769, filed on Sep. 12, 2016.

(30) Foreign Application Priority Data
Mar. 14, 2016 (JP) 2016-049696

(51) Int. Cl. D01D 5/00; B29C 47/30; B29C 47/00

(52) U.S. Cl. CPC D01D 5/0069; B29C 47/0076; B29C 47/30; B29K 2905/12

(57) ABSTRACT

According to one embodiment, a nozzle head includes a main body and a plurality of nozzles. The main body has a space in an interior of the main body. The space is capable of storing a source material liquid. The plurality of nozzles are conductive, are connected to the main body, and eject the source material liquid stored in the interior of the main body. An external dimension of one of the nozzles in a direction orthogonal to an extension direction of the nozzle is different from the external dimension of another one of the nozzles in the direction orthogonal to the extension direction of the nozzle.

### CROSS-REFERENCE TO RELATED APPLICATIONS

This application is based upon and claims the benefit of priority from the Japanese Patent Application No. 2016-049696, filed on Mar. 14, 2016, and the PCT Patent Application PCT/JP2016/076769, filed on Sep. 12, 2016; the entire contents of which are incorporated herein by reference.

### FIELD

An embodiment of the invention relates to a nozzle head and an electrospinning apparatus.

### BACKGROUND

There is an electrospinning apparatus in which a fine fiber is deposited on the surface of a member by electrospinning (also called electric field spinning, charge-induced spinning, etc.).

A nozzle that ejects a source material liquid (hereafter, first liquid) is provided in the electrospinning apparatus. In such a case, the productivity can be increased by increasing the number of nozzles. Therefore, a needle-type nozzle head that includes multiple needle-shaped nozzles has been proposed.

The nozzle that has the needle-like configuration can increase the electric field strength because electric field concentration occurs easily at the tip of the nozzle. Therefore, the drive voltage can be lower by using the needle-type nozzle head.

However, when the multiple nozzles are provided, there is a problem that the electric field strengths of the tips of the nozzles become nonuniform due to electric field interference between the nozzles. When the electric field strengths of the tips of the nozzles are nonuniform, the formation of the fibers becomes unstable.

Therefore, it is desirable to develop technology in which the electric field strengths of the tips of the nozzles can be uniform.

### BRIEF DESCRIPTION OF THE DRAWINGS

FIG. 1 is a schematic view for illustrating an electrospinning apparatus according to the embodiment;

FIG. 2 is a graph for illustrating the electric field strengths of the tips of the multiple nozzles;

FIG. 3 is a graph for illustrating the relationship between the external dimension D of the nozzle and the electric field strength of the tip of the nozzle; and

FIG. 4 is a graph for illustrating the electric field strengths of the tips of the multiple nozzles in the case where the external dimension D of the nozzle is changed.

### DETAILED DESCRIPTION

According to one embodiment, a nozzle head includes a main body and a plurality of nozzles. The main body has a space in an interior of the main body. The space is capable of storing a source material liquid. The plurality of nozzles are conductive, are connected to the main body, and eject the source material liquid stored in the interior of the main body. An external dimension of one of the nozzles in a direction orthogonal to an extension direction of the nozzle is different from the external dimension of another one of the nozzles in the direction orthogonal to the extension direction of the nozzle.

Embodiments will now be illustrated with reference to the drawings. Similar components in the drawings are marked with the same reference numerals; and a detailed description is omitted as appropriate.

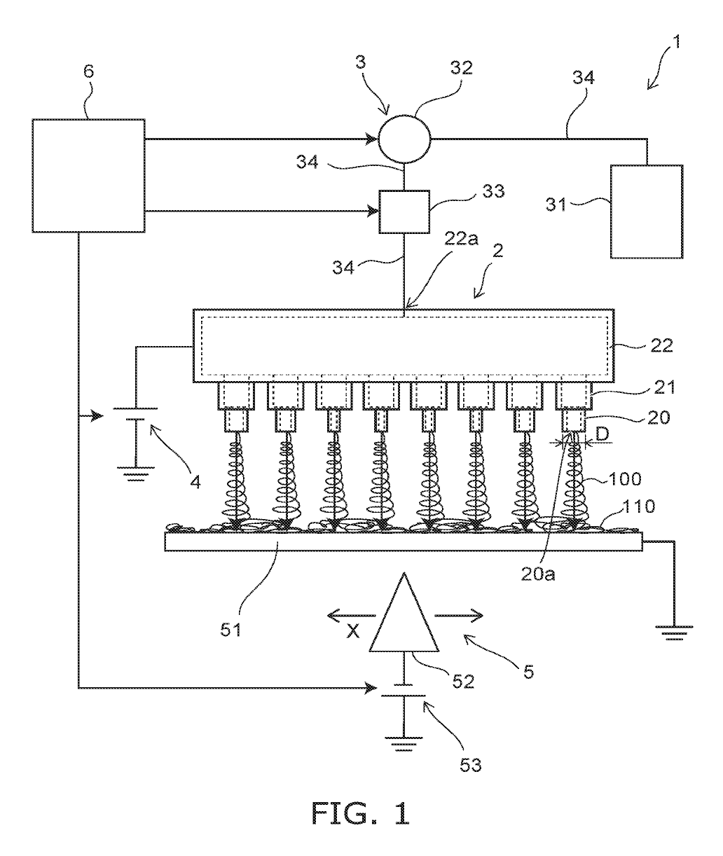

FIG. 1 is a schematic view for illustrating an electrospinning apparatus 1 according to the embodiment.

As shown in FIG. 1, a nozzle head 2, a first liquid supplier 3, a power supply 4, a collector 5, and a controller 6 are provided in the electrospinning apparatus 1.

The nozzle head 2 includes nozzles 20, a connector 21, and a main body 22.

The nozzles 20 are multiply provided at a prescribed spacing. The number of the nozzles 20 is not particularly limited and can be modified appropriately according to the size of a collecting body 51, etc.

The nozzle 20 has a needle-like configuration. A hole for ejecting the first liquid is provided in the interior of the nozzle 20. The hole for ejecting the first liquid communicates between the end portion of the nozzle 20 on the side of the connector 21 and the end portion (the tip) of the nozzle 20 on the side where the first liquid is ejected. An opening of the hole provided in the interior of the nozzle 20 on the side where the first liquid is ejected is an outlet 20a.

Here, if the multiple nozzles 20 are provided, the electric field strengths of the tips of the nozzles 20 become nonuniform due to the electric field interference between the nozzles 20.

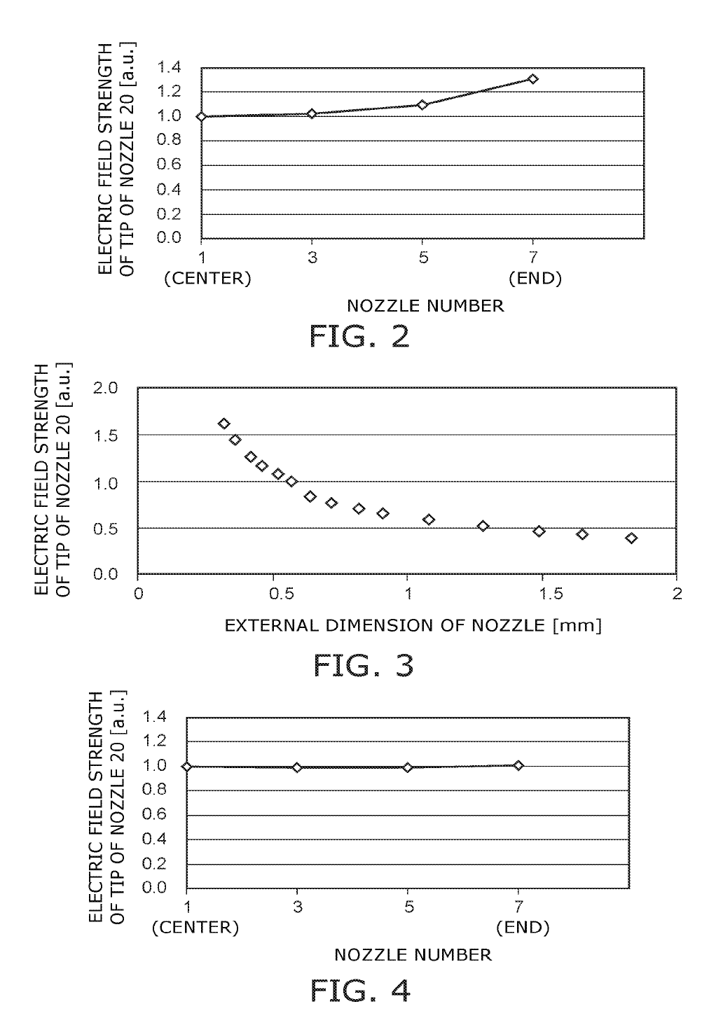

FIG. 2 is a graph for illustrating the electric field strengths of the tips of the multiple nozzles 20.

The number of the nozzles 20 is set to 8. The numeral of the nozzle 20 provided at the center is taken as “1;” the numerals of the nozzles 20 provided on the left side are taken as 3, 5, and 7; and the numerals of the nozzles 20 provided on the right side are taken as 2, 4, 6, and 8. Also, in the case illustrated in FIG. 2, because the distribution of the electric field strength has line symmetry with respect to the center of the nozzle head, only the nozzles 20 provided on the left side (only the nozzles 20 having the odd numerals) are illustrated.

Also, the pitch dimension (the spacing) of the nozzles 20 is set to 15 mm. An external dimension D is set to 0.9 mm for all of the nozzles 20.

It can be seen from FIG. 2 that the electric field strengths of the tips of the nozzles 20 become nonuniform when the multiple nozzles 20 are provided. When the electric field strengths of the tips of the nozzles 20 are nonuniform, the formation of fibers 100 becomes unstable. For example, when the applied voltage is set so that the appropriate fiber 100 is formed for the nozzle 20 provided on the end portion side (the nozzle 20 having the nozzle number of 7), there is a risk that the fiber 100 may not be formed and the first liquid may drop as a liquid droplet for the nozzle 20 provided at the center (the nozzle 20 having the nozzle number of 1).

According to knowledge obtained by the inventor, the electric field strengths of the tips of the nozzles 20 can be controlled using the external dimension D of the nozzle 20 (in the case where the nozzle 20 has a cylindrical configuration, the outer diameter dimension) in a direction orthogonal to the direction in which the nozzles 20 extend.

FIG. 3 is a graph for illustrating the relationship between the external dimension D of the nozzle 20 and the electric field strength of the tip of the nozzle 20.

FIG. 3 shows the electric field strength of one nozzle 20.

It can be seen from FIG. 3 that the electric field strength of the tip of the nozzle 20 can be changed by changing the external dimension D of the nozzle 20.

For example, the electric field strength of the tip of the nozzle 20 can be reduced by increasing the external dimension D of the nozzle 20.

Therefore, the electric field strengths of the tips of the nozzles 20 can be uniform by changing the external dimension D of the nozzle 20 according to the distribution of the electric field strength such as that illustrated in FIG. 2.

FIG. 4 is a graph for illustrating the electric field strengths of the tips of the multiple nozzles 20 in the case where the external dimension D of the nozzle 20 is changed.

The arrangement of the nozzles 20, etc., are the same as the case of FIG. 2.

Similarly to the case of FIG. 2, the external dimension D of the nozzle 20 is set to 0.9 mm for nozzle numbers 1 and 3.

Also, the external dimension D of the nozzle 20 is set to 1.0 mm for nozzle number 5; and the external dimension D of the nozzle 20 is set to 1.2 mm for nozzle number 7.

In other words, the external dimension D of the nozzle 20 provided on the end portion side of the main body 22 is set to be longer than the external dimension of the nozzle 20 provided at the center of the main body 22. Yet in other words, the external dimension D of first nozzle 20 is larger than the external dimension D of the second nozzle 20, where a distance between the first nozzle 20 and a center of the main body 22 is larger than a distance between the second nozzle 20 and the center of the main body 22.

Also, the external dimensions D of the multiple nozzles 20 are set to be longer toward the end portion side of the main body 22. Although nozzles 20 that have the same external dimension D are provided in the case illustrated in FIG. 4, all of the external dimensions D may be different as described below.

It can be seen from FIG. 4 that the electric field strengths of the tips of the nozzles 20 can be uniform by changing the external dimension D of the nozzle 20 according to the distribution of the electric field strengths of the tips of the nozzles 20 such as the illustration in FIG. 2. If the electric field strengths of the tips of the nozzles 20 can be uniform, the formation of the fibers 100 can be stabilized.

Although the external dimension D of the nozzle 20 is set to be longer toward the end portion side in the case illustrated in FIG. 4, this is not limited thereto. It is sufficient to change the external dimension D of the nozzle 20 so that the electric field strengths of the tips of the nozzles 20 are uniform.

Generally, the distribution of the electric field strengths of the tips of the nozzles 20 is as illustrated in FIG. 2. FIG. 2 is the case where the electric field strengths of the tips of the nozzles 20 fluctuate due to the electric field interference between the nozzles 20.

However, for example, there are also cases where the distribution of the electric field strength is unlike that illustrated in FIG. 2 due to electric field interference from the outside.

Therefore, as long as the electric field strengths of the tips of the nozzles 20 can be uniform, the arrangement of the nozzles 20 having different external dimensions D is not particularly limited.

In other words, it is sufficient for the external dimension D in a direction orthogonal to the direction in which the nozzles 20 extend to be different for at least one of the multiple nozzles 20.

In such a case, the external dimensions D of the nozzles 20 and the arrangement of the nozzles 20 having different external dimensions D can be determined by performing experiments, simulations, etc.

The opening dimension of the nozzle 20 on the side where the first liquid is ejected, i.e., the dimension of the outlet 20a (in the case where the nozzle 20 has a cylindrical configuration, the inner diameter dimension), is not particularly limited. The dimension of the outlet 20a can be modified appropriately according to the cross-sectional dimension of the fiber 100 to be formed. The dimension of the outlet 20a can be, for example, 200 μm or more.

In such a case, the dimension of the outlet 20a may be changed according to the external dimension D of the nozzle 20 or may be substantially constant.

The dimension of the outlet 20a being substantially constant includes not only the case where the dimensions of the outlets 20a perfectly match but also includes, for example, the manufacturing fluctuation range of the nozzles 20.

The nozzle 20 is formed from a conductive material. It is favorable for the material of the nozzle 20 to be conductive and to have resistance to the first liquid. For example, the nozzle 20 can be formed from stainless steel, etc.

The connector 21 is provided between the main body 22 and the nozzles 20. The connector 21 is not always necessary; and the nozzles 20 may be provided directly at the main body 22. In other words, it is sufficient for the multiple nozzles 20 to be connected to the main body 22. The holes for supplying the first liquid from the main body 22 to the nozzles 20 are provided in the interior of the connector 21. The holes that are provided in the interior of the connector 21 communicate with the holes provided in the interiors of the nozzles 20 and the space provided in the interior of the main body 22.

The connector 21 is formed from a conductive material. It is favorable for the material of the connector 21 to be conductive and to have resistance to the first liquid. For example, the connector 21 can be formed from stainless steel, etc.

The main body 22 has a plate configuration. A space where the first liquid can be stored is provided in the interior of the main body 22. The nozzles 20 are multiply provided, with the connector 21 interposed, at one end portion of the main body 22. The multiple nozzles 20 are provided to be arranged at a prescribed spacing. The arrangement form of the multiple nozzles 20 is not limited to the illustration. For example, the multiple nozzles 20 can be provided to be arranged in one column, can be provided to be arranged on a circumference or on concentric circles, or can be provided to be arranged in a matrix configuration.

Also, a supply port 22a is provided in the main body 22. The first liquid that is supplied from the first liquid supplier 3 is introduced to the interior of the main body 22 via the supply port 22a. The number and arrangement positions of the supply ports 22a are not particularly limited. For example, the supply port 22a can be provided on the side opposite to the side where the nozzles 20 of the main body 22 are provided.

The first liquid supplier 3 includes a container 31, a supplier 32, a controller 33, and a pipe 34.

The container 31 stores the first liquid. The container 31 is formed from a material having resistance to the first liquid. For example, the container 31 can be formed from stainless steel, etc.

The first liquid includes a polymeric substance dissolved in a solvent.

The polymeric substance is not particularly limited and can be modified appropriately according to the material properties of the fiber 100 to be formed. The polymeric substance can be, for example, polypropylene, polyethylene, polystyrene, polyethylene terephthalate, polyvinyl chloride, polycarbonate, nylon, aramid, etc.

It is sufficient for the solvent to be able to dissolve the polymeric substance. The solvent can be modified appropriately according to the polymeric substance to be dissolved. The solvent can be, for example, water, methanol, ethanol, isopropyl alcohol, acetone, benzene, toluene, etc.

The polymeric substance and the solvent are not limited to those illustrated.

As described below, the first liquid collects at the vicinity of the outlet 20a due to surface tension. To this end, the viscosity of the first liquid can be modified appropriately according to the dimension of the outlet 20a, etc. The viscosity of the first liquid can be determined by performing experiments and/or simulations. Also, the viscosity of the first liquid can be controlled by the mixture proportion of the solvent and the polymeric substance.

The supplier 32 supplies the first liquid stored in the container 31 to the main body 22. For example, the supplier 32 can be a pump that is resistant to the first liquid, etc. Also, for example, the supplier 32 may feed the first liquid stored in the container 31 by pressurizing by supplying a gas to the container 31.

The controller 33 controls the flow rate, pressure, etc., of the first liquid supplied to the main body 22 so that the first liquid in the interior of the main body 22 is not pushed out from the outlet 20a when new first liquid is supplied to the interior of the main body 22. The control amount for the controller 33 can be modified appropriately using the dimension of the outlet 20a, the viscosity of the first liquid, etc. The control amount for the controller 33 can be determined by performing experiments and/or simulations.

Also, the controller 33 may switch between the start of the supply and the stop of the supply of the first liquid.

The supplier 32 and the controller 33 are not always necessary. For example, if the container 31 is provided at a position that is higher than the position of the main body 22, the first liquid can be supplied to the main body 22 by utilizing gravity. Then, the first liquid that is in the interior of the main body 22 can be caused not to be pushed out from the outlet 20a when the new first liquid is supplied to the interior of the main body 22 by appropriately setting the height position of the container 31. In such a case, the height position of the container 31 can be modified appropriately using the dimension of the outlet 20a, the viscosity of the first liquid, etc. The height position of the container 31 can be determined by performing experiments and/or simulations.

The pipe 34 is provided between the container 31 and the supplier 32, between the supplier 32 and the controller 33, and between the controller 33 and the main body 22. The pipe 34 is used as a flow channel of the first liquid. The pipe 34 is formed from a material having resistance to the first liquid.

The power supply 4 applies the voltage to the nozzles 20 via the main body 22 and the connector 21. Not-illustrated terminals that are electrically connected to the multiple nozzles 20 may be provided. In such a case, the power supply 4 applies the voltage to the nozzles 20 via the not-illustrated terminals. In other words, it is sufficient for the voltage to be able to be applied to the multiple nozzles 20 from the power supply 4.

The polarity of the voltage applied to the nozzles 20 can be set to be positive or set to be negative. The power supply 4 illustrated in FIG. 1 applies a positive voltage to the nozzles 20.

The voltage that is applied to the nozzles 20 can be modified appropriately according to the type of polymeric substance included in the first liquid, the distance between the collecting body 51 and the nozzles 20, etc. For example, the power supply 4 can supply a voltage to the nozzles 20 so that the electric potential difference between the collecting body 51 and the nozzles 20 is 10 kV or more.

For example, the power supply 4 can be a direct current-high voltage power supply. For example, the power supply 4 can output a direct current voltage that is not less than 10 kV and not more than 100 kV.

The collector 5 includes the collecting body 51, a deposition adjuster 52, and a power supply 53.

The collecting body 51 is provided on the side of the multiple nozzles 20 where the first liquid is ejected. The collecting body 51 is grounded. A voltage that has the reverse polarity of the voltage applied to the nozzles 20 may be applied to the collecting body 51. The collecting body 51 can be formed from a conductive material. It is favorable for the material of the collecting body 51 to be conductive and to have resistance to the first liquid. For example, the material of the collecting body 51 can be stainless steel, etc.

For example, the collecting body 51 can have a plate configuration or a sheet configuration. In the case where the collecting body 51 has a sheet configuration, the fiber 100 may be deposited on the collecting body 51 that is wound onto a roll, etc.

Also, the collecting body 51 may be able to move. For example, a pair of rotating drums and a driving part that rotates the rotating drums may be provided; and the collecting body 51 that has the sheet configuration may be caused to move between the pair of rotating drums like a belt conveyor. Thus, a continuous deposition operation is possible because the region where the fiber 100 is deposited can be caused to move. Therefore, the production efficiency of a deposited body 110 made of the fiber 100 can be increased.

The deposited body 110 that is formed on the collecting body 51 is removed from the collecting body 51. For example, the deposited body 110 is used in a nonwoven cloth, a filter, etc. The applications of the deposited body 110 are not limited to those illustrated.

Also, the collecting body 51 can be omitted. For example, the deposited body 110 that is made of the fiber 100 can be directly formed on the surface of a conductive member. In such a case, it is sufficient to ground the conductive member or to supply to the conductive member a voltage having the reverse polarity of the voltage applied to the nozzles 20.

The deposition adjuster 52 is provided on the side of the collecting body 51 opposite to the side where the nozzles 20 are provided.

The deposition adjuster 52 is formed from a conductive material. For example, the deposition adjuster 52 can be formed from a metal such as stainless steel, etc.

The end portion of the deposition adjuster 52 on the side of the collecting body 51 is tapered. Electric field concentration occurs easily if the end portion of the deposition adjuster 52 on the side of the collecting body 51 is tapered. Therefore, it is easy to generate the electric field between the deposition adjuster 52 and the nozzles 20.

The power supply 53 applies a voltage to the deposition adjuster 52. The power supply 53 applies, to the deposition adjuster 52, a voltage having the reverse polarity of the voltage applied to the nozzles 20. For example, the power supply 53 can be a direct current-high voltage power supply. For example, the power supply 53 can output a direct current voltage not less than 10 kV and not more than 100 kV.

When the voltage having the reverse polarity of the voltage applied to the nozzles 20 is applied to the deposition adjuster 52, an electric field is generated also between the deposition adjuster 52 and the nozzles 20. The electric field that is generated between the collecting body 51 and the nozzles 20 changes due to effects of the electric field generated between the deposition adjuster 52 and the nozzles 20.

As described below, the first liquid that is at the vicinity of the outlets 20a of the nozzles 20 is drawn out by an electrostatic force acting along the lines of electric force. Therefore, the region where the fibers 100 are deposited can be changed by changing the electric field generated between the collecting body 51 and the nozzles 20.

In other words, the deposition adjuster 52 changes the region where the fibers 100 are deposited by changing the electric field generated between the collecting body 51 and the nozzles 20.

By providing the deposition adjuster 52 and the power supply 53, it becomes easy to deposit the fibers 100 in the desired deposition region.

Also, by providing the deposition adjuster 52 and the power supply 53, it is possible to make the thickness of the deposited body 110 uniform, perform local deposition of the fibers 100, repair opening portions such as pinholes formed in the deposited body 110, etc.

Also, by controlling the voltage applied to the deposition adjuster 52, it is possible to control the electric field generated between the deposition adjuster 52 and the nozzles 20 and even the electric field generated between the collecting body 51 and the nozzles 20.

Also, a not-illustrated drive device that moves the deposition adjuster 52 in the X-direction in FIG. 1 (the direction in which the multiple nozzles 20 are arranged) can be provided. By moving the deposition adjuster 52, the control of the electric field is easier.

Also, the deposition adjuster 52 may be multiply provided.

The controller 6 controls the operations of the supplier 32, the controller 33, the power supply 4, and the power supply 53.

For example, the controller 6 can be a computer including a CPU (Central Processing Unit), memory, etc.

Effects of the electrospinning apparatus 1 will now be described.

The first liquid collects at the vicinity of the outlet 20a of the nozzle 20 due to surface tension.

The power supply 4 applies a voltage to the nozzle 20. Then, the first liquid that is at the vicinity of the outlet 20a is charged with a prescribed polarity. In the case illustrated in FIG. 1, the first liquid that is at the vicinity of the outlet 20a is charged to be positive.

Because the collecting body 51 is grounded, an electric field is generated between the collecting body 51 and the nozzle 20. Then, when the electrostatic force acting along the lines of electric force becomes larger than the surface tension, the first liquid that is at the vicinity of the outlet 20a is drawn out toward the collecting body 51 by the electrostatic force. The first liquid that is drawn out is elongated; and the fiber 100 is formed by the volatilization of the solvent included in the first liquid. The fiber 100 that is formed is deposited on the collecting body 51 to form the deposited body 110.

In the electrospinning apparatus 1 according to the embodiment, the electric field strengths of the tips of the nozzles 20 are caused to be uniform by setting the external dimension D of at least one nozzle 20 of the multiple nozzles 20 to be different. Therefore, the formation of the fibers 100 can be stabilized; and even the quality, production efficiency, etc., of the deposited body 110 can be improved.

Also, the region where the fibers 100 are deposited can be changed by controlling at least one of the voltage applied to the deposition adjuster 52 or the position of the deposition adjuster 52.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A nozzle head, comprising:
a main body having a space in an interior of the main body, the space being capable of storing a source material liquid; and
a plurality of nozzles being conductive, being connected to the main body, and ejecting the source material liquid stored in the interior of the main body,
an external dimension of one of the nozzles in a direction orthogonal to an extension direction of the nozzle being different from the external dimension of another one of the nozzles in the direction orthogonal to the extension direction of the nozzle.

2. The nozzle head according to claim 1, wherein the external dimension of first nozzle is larger than the external dimension of the second nozzle, a distance between the first nozzle and a center of the main body being larger than a distance between the second nozzle and the center of the main body.

3. The nozzle head according to claim 1, wherein the external dimension of the nozzle provided on an end portion side of the main body is longer than the external dimension of the nozzle provided at a center of the main body.

4. The nozzle head according to claim 1, wherein the external dimensions of the plurality of nozzles increase toward the end portion side of the main body.

5. The nozzle head according to claim 1, wherein each of the nozzles has an opening, and opening dimensions of the plurality of nozzles on a side where the source material liquid is ejected are substantially constant.

6. An electrospinning apparatus, comprising:
a main body having a space in an interior of the main body, the space being capable of storing a source material liquid;
a plurality of nozzles being conductive, being connected to the main body, and ejecting the source material liquid stored in the interior of the main body;
a source material liquid supplier supplying the source material liquid to the nozzle head; and
a power supply capable of supplying a voltage to the nozzle head,
an external dimension in a direction orthogonal to an extension direction of the nozzle being different for at least one of the plurality of nozzles.
